(19) United States
(12) Patent Application Publication
(10) Pub. No.: US 2005/0275236 A1
(43) Pub. Date: Dec. 15, 2005

(54) Guide structure for vehicular tray

(75) Inventor: Keun-chul Kim, Yongin-si (KR)

Correspondence Address: GREENBLUM & BERNSTEIN, P.L.C., 1950 ROLAND CLARKE PLACE, RESTON, VA, 20191, US

(73) Assignee: HYUNDAI MOBIS CO., LTD., Seoul (KR)

(21) Appl. No.: 11/109,796

(22) Filed: Apr. 20, 2005

(30) Foreign Application Priority Data
Jun. 11, 2004 (KR) P2004-43181

(51) Int. Cl. B60N 3/12

(52) U.S. Cl. 296/37.9

(57) ABSTRACT

A guide structure for a vehicular tray includes a plurality of slides formed at opposite lateral outer surfaces of the tray, the slides guiding the tray in the movement direction, a plurality of guides formed at opposite lateral inner surfaces of a housing configured to receive the tray, the guides guiding the slides, a plurality of toothed rails installed at lower sides of the guides and formed with teeth in the movement direction of the tray, and toothed gears connected to opposite ends of a damper member and configured to protrude outward from opposite lateral outer surfaces of the tray, the toothed gears being rotated and moved at a constant speed in an engaged state with the toothed rails.

RELATED APPLICATIONS

The present disclosure relates to subject matter contained in Korean Application No. 10-2004-43181, filed on Jun. 11, 2004, which is herein expressly incorporated by reference its entirety.

### BACKGROUND OF THE INVENTION

1. Field of the Invention

The present invention relates to a guide structure for a vehicular tray, and more particularly to a structure for securing smooth guiding operation of a vehicular tray, such as an ashtray provided inside a passenger compartment of an automobile, without hindrance due to cigarette ashes, dust, or the like.

2. Description of the Related Art

Generally, inside most passenger compartments of automobiles, an ashtray for the disposal of cigarette ashes is fitted in an instrument panel, center facia, etc., and the operation of such an ashtray is inevitably affected by the cigarette ashes, dust, or the like.

Now, the structure of a conventional vehicular tray will be explained with reference to the accompanying drawings.

FIG. 1 is a perspective view illustrating an installed state of guide rails and toothed rails constituting a guide structure for a vehicular tray in accordance with the prior art. FIG. 2 is an exploded perspective view of the tray's guide structure shown in FIG. 1.

The vehicular tray 1, of a drawer type, is internally fitted with an inner case 3, and externally formed along both lateral outer surfaces thereof with a pair of elongated guide protrusions 5 extending in the moving direction of the tray 1.

At a rear side of the tray 1 is transversely mounted a damper member 7, and a pair of toothed gears 9 are connected to both ends of the damper member 7 so that they protrude outward from both the lateral outer surfaces of the tray 1.

The tray 1 is received in the interior space of a housing 10. The housing 10 has a pair of toothed rails 14 integrally formed to both lateral inner surfaces 12 thereof, to longitudinally extend near lower ends of the surfaces 12.

To upper ends of the lateral inner surfaces 12 are attached a pair of guide rails 16. The guide rails 16 are formed with grooves having a shape corresponding to the guide protrusions 5.

Disposed on upper surfaces of both guide rails 16 is an upper panel member 18. The upper panel member 18 is fixed to the housing 10 by means of fastening screws 19.

In such a conventional vehicular tray, configured as stated above, the toothed rails 14, integrally formed near the lower ends of the lateral inner surfaces 12 of the housing 10, form a guide structure. The toothed rails 14 are engaged with the toothed gears 9 of the tray 1, enabling the toothed gears 9 to move therealong, while adjusting a movement speed of the tray 1. With such a guide structure, however, the toothed rails 14 may cause malfunction of the tray 1 if foreign substances such as cigarette ashes were to enter thereinto.

Another problem of the above-described guide structure is that, since the toothed rails 14 are integrally formed to the lateral inner surfaces 12 of the housing 10, in order to change the design of the toothed rails 14, a mold thereof must be wholly changed, resulting in complication in the shape of the mold, increasing manufacturing costs of the mold.

### SUMMARY OF THE INVENTION

Therefore, the present invention has been made in view of the above problems, and it is an object of the present invention to provide a guide structure for a vehicular tray which can secure smooth guiding operation of the tray even if foreign substances, such as cigarette ashes or dust, entered, resulting in improved operational reliability of the tray.

It is another object of the present invention to provide a guide structure for a vehicular tray which can reduce manufacturing costs of a mold and ensure easy design change of the mold through the provision of toothed rails, which are separable from a housing.

In accordance with the present invention, the above and other objects can be accomplished by the provision of a guide structure for a vehicular tray comprising: sliding means formed at both lateral outer surfaces of the tray for guiding the tray in the movement direction; guide means, formed at both lateral inner surfaces of a housing configured to receive the tray, for guiding the sliding means; toothed rails, installed at lower sides of the guide means and formed with teeth in the movement direction of the tray; and toothed gears, connected to both ends of a damper member so that they protrude outward from both the lateral outer surfaces of the tray, the toothed gears being rotated and moved at a constant speed in an engaged state with the toothed rails.

Preferably, the sliding means may include elongated guide protrusions formed at both the lateral outer surfaces of the tray, and the guide means, into which the guide protrusions are inserted and guided therein, and which may include guide rails internally formed with grooves.

Preferably, the toothed rails may be integrally formed with the guide means.

With the present invention as stated above, it is possible to prevent malfunction of the tray due to cigarette ashes, dust, or the like during the operation of the tray, providing more smooth operation of the tray.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a perspective view illustrating an installed state of guide rails and toothed rails of a guide structure for a vehicular tray in accordance with the prior art;

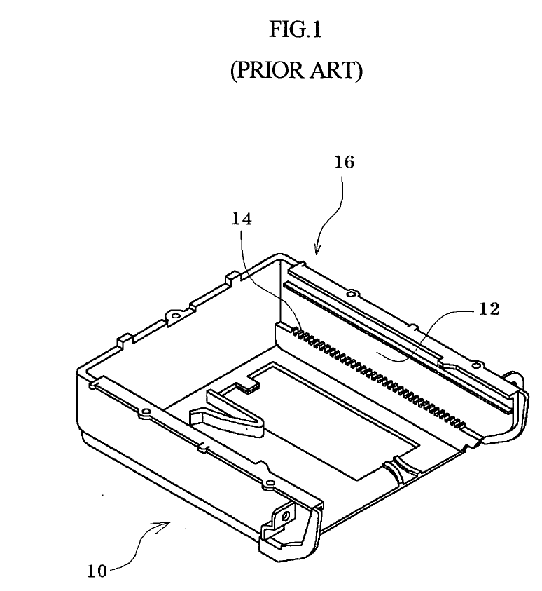

FIG. 2 is an exploded perspective view of the tray's guide structure shown in FIG. 1;

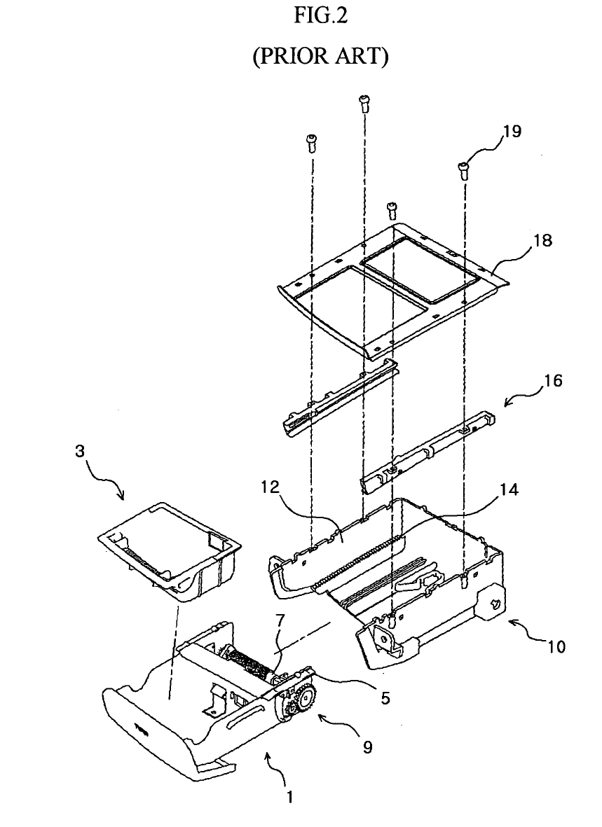

FIG. 3 is a perspective view illustrating an installed state of guide rails and toothed rails of a guide structure for a vehicular tray in accordance with the present invention; and

FIG. 4 is an exploded perspective view of the tray's guide structure shown in FIG. 3.

### DESCRIPTION OF THE PREFERRED EMBODIMENTS

Now, a preferred embodiment of the present invention will be explained with reference to the accompanying drawings.

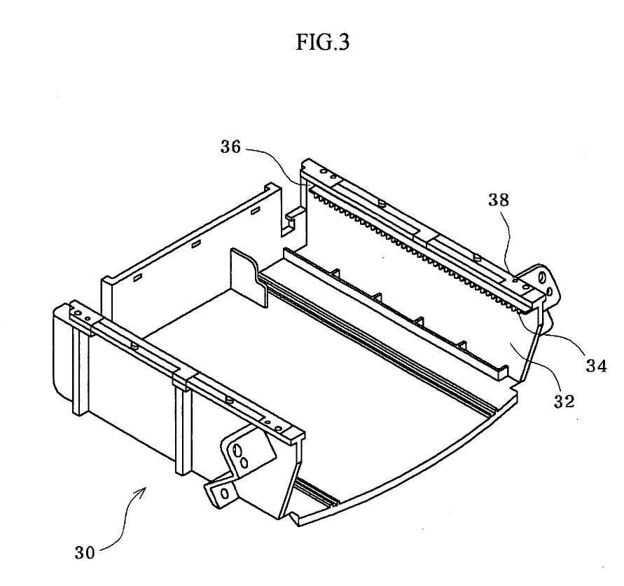

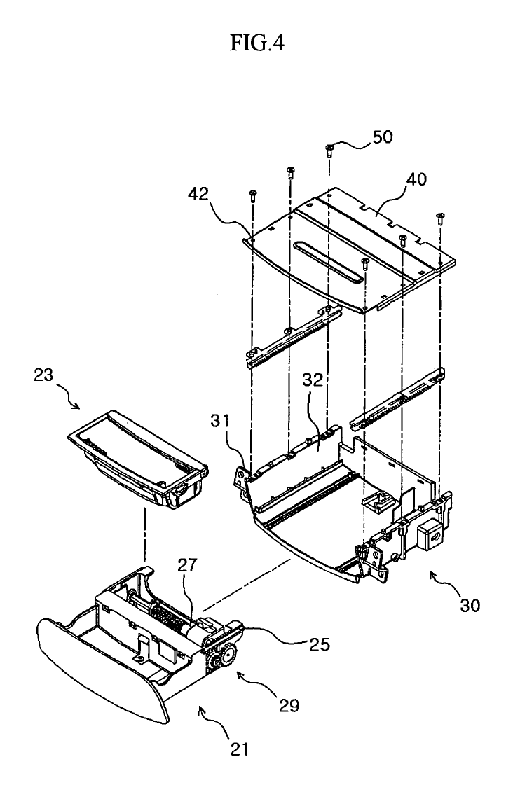

FIG. 3 is a perspective view illustrating an installed state of guide rails and toothed rails of a guide structure for a vehicular tray in accordance with the present invention, and FIG. 4 is an exploded perspective view of the tray guide structure shown in FIG. 3.

The tray of the present invention, which is designated as reference numeral 21, is internally fitted with an inner case 23 for allowing a user to flick ashes from a cigarette, and externally formed at both lateral outer surfaces thereof with a pair of elongated guide protrusions 25 extending in the moving direction of the tray 21.

At a rear side of the tray 21 is provided a damper member 27. The damper member 27 serves to adjust a movement speed of the tray 21 and keep it at a constant level.

To both ends of the damper member 27 are connected a pair of toothed gears 29, so that the toothed gears 29 protrude outward from both the lateral outer surfaces of the tray 21.

Such a damper member 27 is received inside part of a housing 30. The housing 30 is provided with a pair of mounts 31 externally coupled to an upper end of the housing 30, and a pair of guide rails 36 attached to lateral inner surfaces 32 thereof To the guide rails 36 are integrally formed a pair of toothed rails 34, respectively.

Along one side of each of the guide rails 36 is provided connectors 38, which are used to mount an upper panel member 40 above the guide rails 36.

The upper panel member 40 has through-holes 42 corresponding to the connectors 38 of the guide rails 36. Fastening screws 15 are provided to fix the upper panel member 40, guide rails 36, and consequently the toothed rails 34, to the housing 30.

In the present embodiment, although the guide protrusions 25 provided at both the lateral outer surfaces of the tray 21 form sliding means, and the guide rails 36 provided at both the lateral inner surfaces of the housing 30 form guide means, it should be understood that the sliding means and guide means can be modified in various manners within the sprit of the present invention so long as they can secure smooth sliding operation of the tray 21.

Now, the operation and effects of the guide structure for a vehicular tray in accordance with the above-described preferred embodiment of the present invention will be explained.

In a state wherein the inner case 23 is fitted inside the tray 21, the guide rails 36 integrally formed with the toothed rails 34 are mounted between the upper panel member 40 and the housing 30 by means of the fastening screws 50, so that they protrude inward from the lateral inner surfaces 32 of the housing 30.

In such an assembled state, the guide protrusions 25 of the tray 21 are movable in a sliding manner along the guide rails 36, and the toothed gears 29 are rotatable and movable in an engaged state with the toothed rails 34, enabling adjustment of a movement speed of the tray 21.

Since the toothed rails 34, movably engaged with the toothed gears 29, are located at upper positions of the lateral inner surfaces 32 of the housing 30, even if cigarette ashes, dust, or other foreign substances were to enter between the tray 21 and the housing 30, they have no effect on such an upper portion wherein the toothed gears 29 come into contact with the toothed rails 34.

Further, since the toothed rails 34 are separable from the housing 30 by removing the guide rails 36 from the housing 30, the overall shape of a mold of the housing 30 is simplified, resulting in reduction in manufacturing costs of the mold as well as ease in design change of the mold.

As apparent from the above description, the present invention provides a guide structure for a vehicular tray which can secure smooth guiding operation of the tray even if cigarette ashes, dust, or other foreign substances were to enter, since toothed rails, to be engaged with toothed gears, are positioned at a relatively high level, resulting in improved operational reliability.

Further, according to the present invention, since the toothed rails are integrally formed to lower sides of guide rails so that they are separable from a housing, the overall shape of the housing can be simplified, resulting in ease in design change of a mold of the housing, and reducing manufacturing costs of the mold.

Although the preferred embodiment of the present invention have been disclosed for illustrative purposes, those skilled in the art will appreciate that various modifications, additions and substitutions are possible, without departing from the scope and spirit of the invention as disclosed in the accompanying claims.

1. A guide structure for a vehicular tray comprising:
a slide formed at opposite lateral outer surfaces of the tray, the slides guiding the tray in the movement direction;
a guide formed at opposite lateral inner surfaces of a housing configured to receive the tray, the guides guiding the slides;
toothed rails installed at lower sides of the guides and formed with teeth in the movement direction of the tray; and
toothed gears connected to opposite ends of a damper member and configured to protrude outward from opposite lateral outer surfaces of the tray, the toothed gears being rotated and moved at a constant speed in an engaged state with the toothed rails.

2. The structure as set forth in claim 1, wherein the slides comprise elongated guide protrusions formed at opposite lateral outer surfaces of the tray; and
the guides, into which the guide protrusions are inserted and guided therein, includes guide rails internally formed with grooves.

3. The structure as set forth in claim 1, wherein the toothed rails are integrally formed with the guides.
